(19) United States
(12) Patent Application Publication
(10) Pub. No.: US 2025/0355210 A1
(43) Pub. Date: Nov. 20, 2025

(54) HOLDING JIG, OPTICAL CABLE HOLDING SYSTEM, AND OPTICAL CABLE DRAWING METHOD

(71) Applicants: SUMITOMO ELECTRIC INDUSTRIES, LTD., Osaka-shi (JP); SUMITOMO ELECTRIC OPTIFRONTIER CO., LTD. ., Yokohama-shi (JP)

(72) Inventors: Shunichi WATANABE, Osaka-shi (JP); Takayuki Shimazu, Osaka-shi (JP); Junji Fukui, Yokohama-shi (JP); Masahiro Shibata, Yokohama-shi (JP); Yohei Aoshima, Yokohama-shi (JP)

(73) Assignees: SUMITOMO ELECTRIC INDUSTRIES, LTD., Osaka-shi (JP); SUMITOMO ELECTRIC OPTIFRONTIER CO., LTD., Yokohama-shi (JP)

(21) Appl. No.: 19/213,642

(22) Filed: May 20, 2025

(30) Foreign Application Priority Data
May 20, 2024 (JP) 2024-081959

(51) Int. Cl. G02B 6/44

(52) U.S. Cl. CPC G02B 6/44785; G02B 6/4478

(57) ABSTRACT

A holding jig is attachable to a plurality of optical cables to hold the plurality of optical cables in parallel to each other. The holding jig includes a plurality of gripping portions. Each of the plurality of gripping portions is configured to grip a sheath of an optical cable. Each of the plurality of gripping portions includes a first end portion and a second end portion and extends in a first direction. The first direction is, in a state in which the sheath of the optical cable is gripped, a direction from the first end portion toward the second end portion which is along an axis of the optical cable and also a direction parallel to the axis of the optical cable. The plurality of gripping portions are coupled side by side so as to grip the plurality of optical cables arranged in parallel.

### TECHNICAL FIELD

The present disclosure relates to a holding jig, an optical cable holding system, and an optical cable drawing method. This application is based on and claims priority under 35 USC 119 from Japanese Patent Application No. 2024-081959 filed on May 20, 2024, the contents of which are incorporated herein by reference.

### BACKGROUND

JP2023-083096A discloses an optical branching cable that connects a server rack group, including a plurality of server racks, and a distribution board. The optical branching cable includes a main cable and branching cords that branch from the main cable and that are connected to the server racks.

### SUMMARY

A holding jig according to an aspect of the present disclosure is a holding jig attachable to a plurality of optical cables to hold the plurality of optical cables in parallel to each other, the holding jig including a plurality of gripping portions, each of the plurality of gripping portions being configured to grip a sheath of an optical cable, in which: each of the plurality of gripping portions includes a first end portion and a second end portion and extends in a first direction, the first direction being, in a state in which the sheath of the optical cable is gripped, a direction from the first end portion toward the second end portion which is along an axis of the optical cable and also a direction parallel to the axis of the optical cable; and the plurality of gripping portions are coupled side by side so as to grip the plurality of optical cables arranged in parallel.

### BRIEF DESCRIPTION OF DRAWINGS

FIG. 1 shows an optical communication system according to the present embodiment.

FIG. 2 is a schematic view of an optical branching cable.

FIG. 3 is a cross-sectional view of a main cable.

FIG. 4 is a schematic diagram of an optical cable holding system.

FIG. 5 is a perspective view of a first holding jig.

FIG. 6 is a cross-sectional view on arrow taken along a line VI-VI in FIG. 5.

FIG. 7 illustrates the first holding jig as viewed in a direction indicated by an arrow VII in FIG. 5.

FIG. 8 is a perspective view of a third holding jig.

FIG. 9 is a cross-sectional view on arrow taken along a line IX-IX in FIG. 8.

FIG. 10 is a cross-sectional view taken along a plane perpendicular to an axis of the main cable of the optical cable holding system.

FIG. 11 shows a holding jig according to a first modification.

FIG. 12 shows a holding jig according to a second modification.

### DETAILED DESCRIPTION

Depending on the number of server racks arranged in a server rack group, a plurality of optical cables may be required to be installed in a parallel state so as to extend in the same direction. When the number of optical cables is large, work of installation of the optical cables becomes complicated.

An object of an aspect of the present disclosure is to provide a holding jig, an optical cable holding system, and an optical cable drawing method, which improve workability in optical cable installation.

According to an aspect of the present disclosure, it is possible to provide a holding jig, an optical cable holding system, and an optical cable drawing method, which improve workability in optical cable installation.

### Description of Embodiment of Present Disclosure

Aspects of the present disclosure will be listed and described.

(1) A holding jig according to one aspect of the present disclosure is a holding jig attachable to a plurality of optical cables to hold the plurality of optical cables in parallel to each other, the holding jig including a plurality of gripping portions, each of the plurality of gripping portions being configured to grip a sheath of an optical cable, in which: each of the plurality of gripping portions includes a first end portion and a second end portion and extends in a first direction, the first direction being, in a state in which the sheath of the optical cable is gripped, a direction from the first end portion toward the second end portion which is along an axis of the optical cable and also a direction parallel to the axis of the optical cable, and the plurality of gripping portions are coupled side by side so as to grip the plurality of optical cables arranged in parallel.

According to the above holding jig, the plurality of gripping portions are coupled side by side so as to grip the plurality of optical cables arranged in parallel. Consequently, when the plurality of optical cables are gripped by the plurality of gripping portions, it is easy to maintain the optical cables in a parallel state. Further, when the optical cables to which the holding jig is attached are drawn, the parallel arrangement of the plurality of optical cables is easily maintained even after the drawing operation. Consequently, it is more efficient as compared with the work procedure in which the optical cables are drawn one by one, and it is possible to reduce a work load of aligning the optical cables after the drawing. In this way, workability of installation of the optical cables is improved.

(2) In the holding jig according to the above (1), in a cross section of each of the plurality of gripping portions taken along a plane perpendicular to the first direction, an inner circumference of each of the plurality of gripping portions may define an arc with an opening in a part of a circle, and in two adjacent gripping portions of the plurality of gripping portions, directions in which openings of the two adjacent gripping portions are positioned with respect to respective inner circumferential centers of the two adjacent gripping portions may be different from each other.

According to the above holding jig, when the directions of the openings in the plurality of gripping portions are aligned with respect to a cross-sectional center of the gripping portions, a reaction force when gripping the optical cables may cause the holding jig to bend convexly in the direction in which the gripping portions are open. When attached to the optical cables, adjacent gripping portions open in different directions, whereby it is difficult for the holding jig to bend in one direction.

(3) In the holding jig according to the above (2), the arc defined by the inner circumference of each of the plurality of gripping portions may have a diameter in a range of 70% to 90% of an outer diameter of the optical cable.

According to the above holding jig, an inner surface of the gripping portion is formed in an arc shape with an inner diameter in a range of 70% to 90% of the outer diameter of the optical cable, so that the optical cable is less likely to fall off from the gripping portion.

(4) In the holding jig according to any one of the above (1) to (3), two or more protrusions may be formed at different positions on an inner surface of each of the plurality of gripping portions.

According to the above holding jig, when the optical cable is gripped by the gripping portion, the protrusions make it difficult for the optical cable to be displaced or rotated inside the gripping portion. In this way, it becomes difficult for the optical cable to fall off from the gripping portion or be twisted.

(5) In the holding jig according to any one of the above (1) to (4), each of the plurality of gripping portions may include: a central portion having a constant outer diameter; and a tapered portion including an end portion which is one of the first end portion and the second end portion, the tapered portion having an outer diameter that decreases toward the end portion.

According to the above holding jig, when a drawing path is flat, the holding jig is drawn while the central portion having a constant thickness contacts a traveling surface, so that a posture of the holding jig during drawing is stable. On the other hand, when a protrusion is formed on the drawing path, the tapered portion contacts the protrusion, whereby the holding jig easily climb over the protrusion. In this way, workability of installation of the optical cables is improved.

(6) In the holding jig according to any one of the above (1) to (5), adjacent ones of the plurality of gripping portions may be formed at different positions in the first direction.

According to the above holding jig, adjacent gripping portions are formed at different positions in the first direction, so that the holding jig has flexibility, whereby the holding jig is allowed to be partially deformed in the first direction or in a direction opposite to the first direction. As a result, even when the drawing path is not flat or is curved, the drawn jig deforms while the optical cables are being drawn, whereby the parallel arrangement of the optical cables is easily maintained.

(7) In the holding jig according to the above (1), in a cross section of each of the plurality of gripping portions taken along a plane perpendicular to the first direction, an inner circumference of each of the gripping portions may define an arc with an opening in a part of a circle, in two adjacent gripping portions of the plurality of griping portions, directions in which openings of the two adjacent gripping portions are positioned with respect to respective inner circumferential centers of the two adjacent gripping portions may be a same direction, the holding jig may further include a lid configured to close openings of the plurality of gripping portions, and the lid may be attachable to the plurality of gripping portions so as to close the openings of the plurality of gripping portions in a state in which the plurality of optical cables are gripped by the plurality of gripping portions.

According to the above holding jig, a flat surface of the lid closes the opening of the gripping portion, whereby it is difficult for the optical cable to fall off from the gripping portion. When the plurality of gripping portions are open in, for example, only one direction, a reaction force when gripping the optical cables may cause the holding jig to bend convexly in the direction in which the gripping portions are open. By closing the openings of the gripping portions with the lid, the holding jig is less likely to bend in one direction.

(8) In the holding jig according to the above (1), the plurality of gripping portions may include a first gripping portion and a second gripping portion, the first gripping portion and the second gripping portion may define a continuous accommodation space configured to accommodate two of the plurality of optical cables, and an extension portion may be formed on an outer surface of the holding jig, the extension portion extending in a direction from the first gripping portion toward the second gripping portion.

According to the above-mentioned holding jig, two optical cables can be held in one accommodation space, and therefore the shape of the gripping portion can be simplified. Since the extension portion is formed, the optical cable can be easily taken out from the accommodation space by holding the extension portion.

(9) An optical cable holding system according to one aspect of the present disclosure includes: the holding jig according to any one of the above (1) to (8); and two or more optical cables, a number of the two or more optical cables being equal to or less than a total number of optical cables that are permitted to be gripped by the plurality of gripping portions, in which the two or more optical cables are gripped by respective two or more gripping portions of the plurality of gripping portions such that the two or more optical cables are arranged in parallel.

According to the above optical cable holding system, by attaching the holding jig to the optical cables, the parallel arrangement state of the plurality of optical cables is easily maintained even during installation work. When the optical cables gripped by the holding jig are drawn, the parallel arrangement of the plurality of optical cables is easily maintained even after the drawing operation. Consequently, it is more efficient as compared with a work procedure in which the optical cables are drawn one by one, and it is possible to reduce the work of aligning the optical cables after drawing. In this way, workability of installation of the optical cables is improved.

(10) An optical cable holding system according to another aspect of the present disclosure includes: a plurality of optical cables; a first holding jig attachable to a first optical cable group including at least two optical cables of the plurality of optical cables to hold the at least two optical cables in parallel to each other, the first holding jig including a plurality of first gripping portions, each of the plurality of first gripping portions being configured to grip a sheath of an optical cable; a second holding jig attachable to a second optical cable group including at least two other optical cables of the plurality of optical cables to hold the at least two other optical cables in parallel to each other, the second holding jig including a plurality of second gripping portions, each of the plurality of second gripping portions being configured to grip a sheath of an optical cable; and a third holding jig including two third gripping portions, each of the two third gripping portions being configured to grip a sheath of an optical cable, in which: each gripping portion among each of the plurality of first gripping portions, each of the plurality of second gripping portions, and each of the two third gripping portions includes a first end portion and a second end portion and extends in a first direction, the first direction being, in a state in which the sheath of the optical cable is gripped, a direction from the first end portion toward the second end portion which is along an axis of the optical cable and also a direction parallel to the axis of the optical cable; the plurality of first gripping portions are coupled side by side so as to grip the at least two optical cables included in the first optical cable group; the plurality of second gripping portions are coupled side by side so as to grip the at least two other optical cables included in the second optical cable group; the two third gripping portions define a continuous accommodation space configured to accommodate two of the plurality of optical cables; a number of the plurality of optical cables is two or more and equal to or less than a total number of optical cables that are permitted to be gripped by the plurality of first gripping portions and the plurality of second gripping portions; the first optical cable group and the second optical cable group are arranged side by side such that a first optical cable contained in the first optical cable group and a second optical cable contained in the second optical cable group are positioned adjacent to each other; and the third holding jig is configured to hold the first optical cable and the second optical cable in a state in which the first optical cable and the second optical cable are accommodated in the continuous accommodation space.

According to the above optical cable holding system, the first optical cable group and the second optical cable group are held by the third holding jig. When the optical cable holding system is drawn along a linear drawing path, the optical cable holding system is drawn in a state in which the first optical cable group and the second optical cable group are held by the third holding jig, so that the first optical cable group and the second optical cable group are drawn in a parallel state. When the optical cable holding system is drawn along a curved drawing path, the optical cable holding system is drawn in a state in which the holding of the first optical cable group and the second optical cable group by the third holding jig is released, so that the first optical cable group can adopt a free position relative to the second optical cable group. The optical cable holding system is drawn while deforming along the curved drawing path, so that the system can travel smoothly along the curved drawing path. In this way, workability of installation of the optical cables is improved.

(11) An optical cable drawing method according to one aspect of the present disclosure is an optical cable drawing method for drawing the optical cables in the optical cable holding system according to the above (9) or (10), the optical cable drawing method including drawing the optical cable holding system along a drawing path in a state in which the optical cables are held by the holding jig.

According to the above drawing method for an optical cable, by attaching the holding jig to the optical cables, the parallel arrangement state of the plurality of optical cables is easily maintained even during installation work. When the optical cables gripped by the holding jig are drawn, the parallel arrangement of the plurality of optical cables is easily maintained even after the drawing operation. Consequently, it is more efficient as compared with a work procedure in which the optical cables are drawn one by one, and it is possible to reduce the work of aligning the optical cables after drawing. In this way, workability of installation of the optical cables is improved.

(12) An optical cable drawing method according to another aspect of the present disclosure is an optical cable drawing method for drawing the plurality of optical cables in the optical cable holding system according to the above (10) including drawing the optical cable holding system along a drawing path, in which: in a case in which the drawing path is a linear drawing path, the optical cable holding system is drawn in a state in which the plurality of optical cables are gripped by the first holding jig, the second holding jig, and the third holding jig; and in a case in which the drawing path is a curved drawing path, the optical cable holding system is drawn in a state in which the plurality of optical cables are gripped by the first holding jig and the second holding jig but not gripped by the third holding jig.

According to the above drawing method for an optical cable, the first optical cable group and the second optical cable group are held by the third holding jig. When the optical cable holding system is drawn along a linear drawing path, the optical cable holding system is drawn in a state in which the first optical cable group and the second optical cable group are held by the third holding jig, so that the first optical cable group and the second optical cable group are drawn in a parallel state. When the optical cable holding system is drawn along a curved drawing path, the optical cable holding system is drawn in a state in which the holding of the first optical cable group and the second optical cable group by the third holding jig is released, so that the first optical cable group can adopt a free position relative to the second optical cable group. The optical cable holding system is drawn while deforming along the curved drawing path, so that the system can travel smoothly along the curved drawing path. In this way, workability of installation of the optical cables is improved.

### Details of Embodiments of Present Disclosure

Specific examples of an optical branching cable and an optical branching cable set according to an embodiment of the present disclosure will be described below with reference to the drawings. Note that the present disclosure is not limited to these exemplifications, but is indicated by the scope of claims, and is intended to include all changes within a scope and meaning equivalent to the scope of claims.

In the drawings, an arrow F indicates a forward direction of the illustrated structure. An arrow B indicates a backward direction of the illustrated structure. An arrow U indicates an upward direction of the illustrated structure. An arrow D indicates a downward direction of the illustrated structure. An arrow R indicates a rightward direction of the illustrated structure. An arrow L indicates a leftward direction of the illustrated structure. These expressions related to the directions are used for convenience of description, and are not intended to limit the posture and direction of the illustrated structure in the actual use state.

### Optical Branching Cable

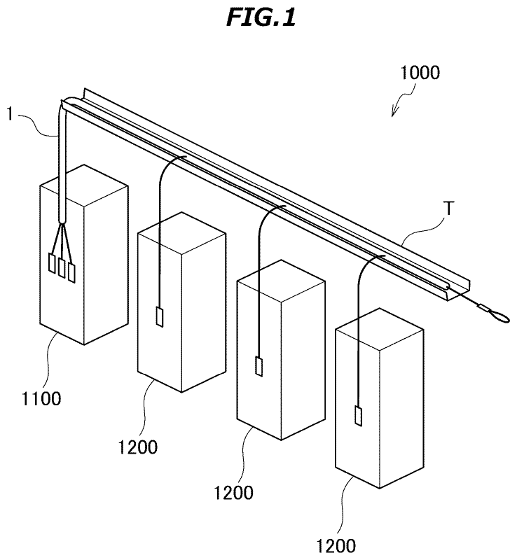

FIG. 1 shows an optical communication system 1000 according to the present embodiment. As shown in FIG. 1, the optical communication system 1000 includes a distribution board 1100 and a plurality of server racks 1200. Optical branching cables 1 used in the optical communication system 1000 are collected and held to the distribution board 1100.

The optical branching cable 1 is an example of an optical cable. The server rack 1200 accommodates a physical server therein. An optical fiber that is branched from the optical branching cable 1 is connected to each of the server racks 1200. The optical branching cable 1 is installed on a cable installation tray T, and is wired to the distribution board 1100 and the server rack 1200. The cable installation tray Tis an example of a drawing path.

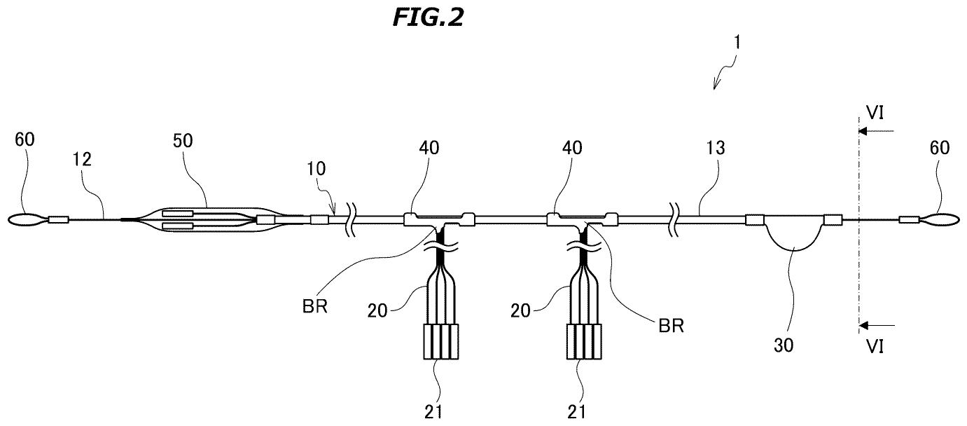

FIG. 2 is a schematic view of the optical branching cable 1. As shown in FIG. 2, the optical branching cable 1 includes a main cable 10, a branching cord portion 20, a branching cord bag 30, a bend restricting component 40, a distal end bag 50, and a connection loop 60.

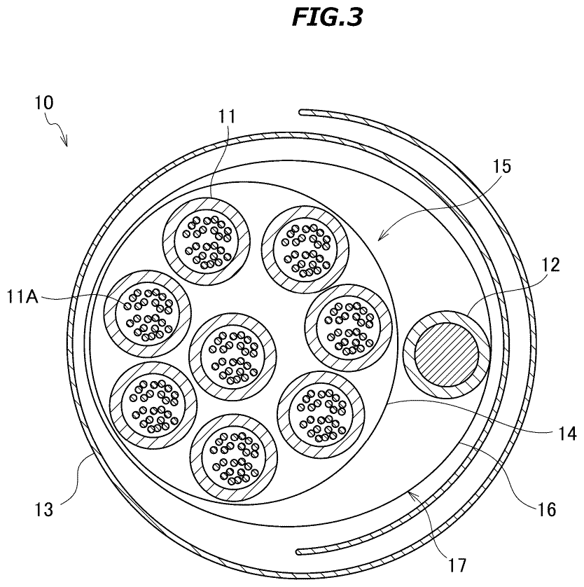

FIG. 3 is a cross-sectional view of the main cable 10. The main cable 10 includes a plurality of optical cords 11, a tensile strength member 12, and a tape 13. The optical cords 11, the tensile strength member 12, and the tape 13 are arranged along a longitudinal direction of the main cable 10. The main cable 10 is also an example of the optical cable.

Each of the optical cords 11 includes at least one optical fiber 11A therein. In the present embodiment, the optical cord 11 includes 24 optical fibers 11A therein. The plurality of optical cords 11 are bundled together in a first bundle 14 to form an optical cord group 15.

The tensile strength member 12 is made of fiber reinforced plastic (FRP) such as aramid FRP, glass FRP, or carbon FRP. The tensile strength member 12 is configured to share the tension when the optical branching cable 1 is drawn, so that excessive tension is not applied to the optical fiber 11A. The optical cord group 15 and the tensile strength member 12 are bundled together in a second bundle 16 to form a core portion 17.

The tape 13 forms an outermost layer of the main cable 10. The tape 13 is longitudinally folded around the core portion 17 so as to maintain a shape that covers the core portion 17. The tape 13 is a sheet-shaped insulating resin, and may be made of, for example, polyester.

The tape 13 is longitudinally folded such that a gap is formed between the tape 13 and the core portion 17. Therefore, an outer diameter of the main cable 10 is configured to be contracted by an external force.

Returning to FIG. 2, the branching cord portion 20 is a cord in which at least one optical fiber 11A is led out from the optical cord 11 of the main cable 10 to the outside of the tape 13 which is the outermost layer. An optical connector 21 is provided at a distal end of the branching cord portion 20. The branching cord portion 20 may be a portion in which the optical fiber 11A in the optical cord 11 is led outward from the outermost layer of the main cable 10, or the optical cord 11 itself may be led outward from the outermost layer of the main cable 10.

The branching cord bag 30 is configured to accommodate the branching cord portion 20 and the optical connector 21. The branching cord portion 20 is accommodated in the branching cord bag 30 when there is no need to connect to the server rack 1200 (see FIG. 1), such as during transportation of the optical branching cable 1. The branching cord bag 30 is configured to accommodate the branching cord portion 20 with at least a part of the branching cord portion 20 wound in a coil shape.

In the present embodiment, one branching cord bag 30 is capable of accommodating one branching cord portion 20, but one branching cord bag 30 may also be formed to be able to collectively accommodate the branching cord portions 20 of a plurality of parallel arranged optical branching cables 1.

The bend restricting component 40 is mounted at a position corresponding to a branching portion BR of the optical branching cable 1. The bend restricting component 40 is provided at the branching portion BR such that bending with a bend radius smaller than a predetermined bend radius is less likely to occur in the branching cord portion 20 led out from the main cable 10.

The distal end bag 50 protects an end portion of the optical cord 11 that is exposed at the distal end of the main cable 10, and an end portion optical connector that is provided at the end portion of the optical cord 11.

The connection loop 60 is connected to the tensile strength member 12 that is exposed at the distal end of the optical branching cable 1. The connection loop 60 is a portion that is connected to a drawing device such as a winch. The connection loop 60 is formed in a ring shape, and when the connection loop 60 is drawn, a tension is applied to the tensile strength member 12, and the optical branching cable 1 can be displaced.

### Holding Jig

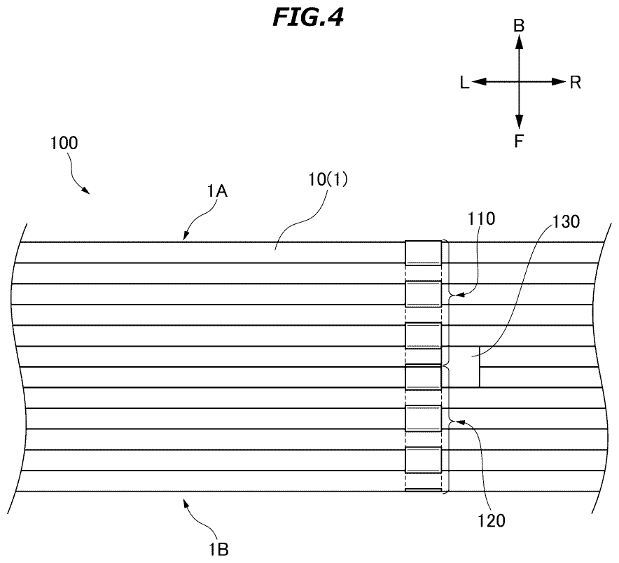

Next, a holding jig to be attached to the optical branching cable 1 will be described. FIG. 4 is a schematic diagram of an optical cable holding system 100. As shown in FIG. 4, the optical cable holding system 100 includes two or more optical branching cables 1, a first holding jig 110, a second holding jig 120, and a third holding jig 130. The first holding jig 110, the second holding jig 120, and the third holding jig 130 are all examples of the holding jig.

Two or more optical branching cables 1 are arranged in parallel in a direction intersecting with the rightward direction. In the present embodiment, twelve optical branching cables 1 are arranged side by side in the forward direction. Each of the twelve optical branching cables 1 is held together with adjacent optical branching cables 1 in the forward direction and the backward direction by at least one of the first holding jig 110, the second holding jig 120, and the third holding jig 130.

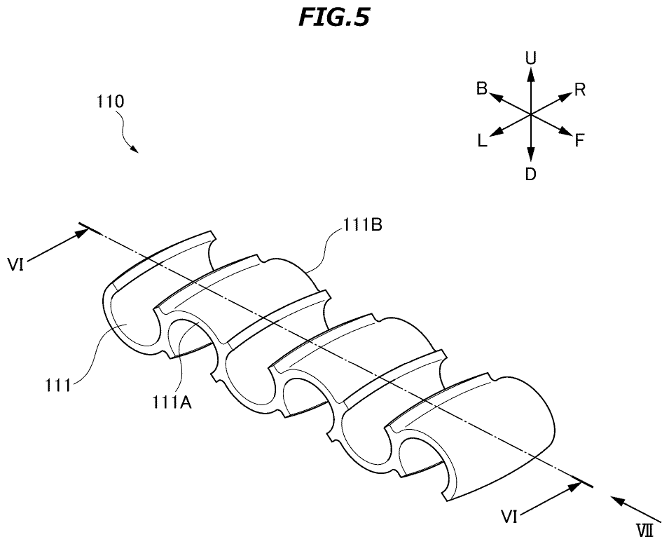

FIG. 5 is a perspective view of the first holding jig 110. Note that since the first holding jig 110 and the second holding jig 120 have the same dimensions and shape, a description of the second holding jig 120 will be omitted.

As shown in FIG. 5, the first holding jig 110 includes a plurality of gripping portions 111. In the present embodiment, the first holding jig 110 includes six gripping portions 111. Each of the gripping portions 111 is formed to be able to grip the tape 13 which is the sheath of the optical branching cable 1. In the present embodiment, each of the six gripping portions 111 is formed in a cylindrical shape with a part of a side surface thereof being opened.

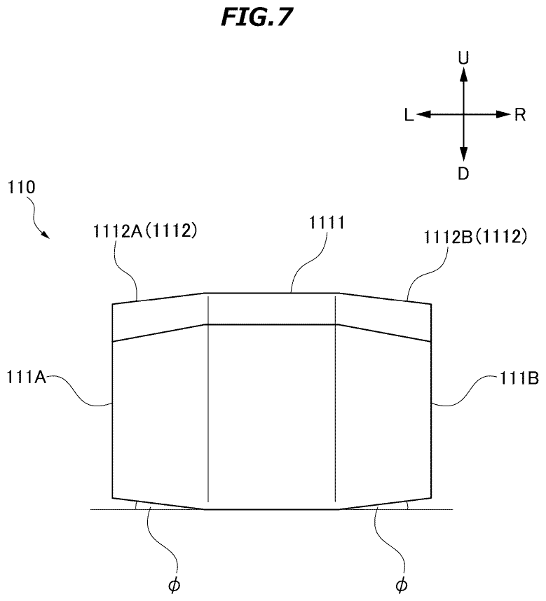

The gripping portion 111 includes a first end portion 111A which is an end portion in the leftward direction, and a second end portion 111B which is an end portion in the rightward direction (see also FIG. 7). Each of the gripping portions 111 is formed to extend in a first direction parallel to an axis of the optical branching cable 1, which is a direction from the first end portion 111A to the second end portion 111B along the axis of the optical branching cable 1. That is, in the present embodiment, the first direction is the rightward direction.

The plurality of gripping portions 111 are coupled side by side so as to grip the plurality of optical branching cables 1 arranged in parallel. In the present embodiment, as shown in FIG. 4, when the gripping portions 111 of the first holding jig 110 grip six optical branching cables 1, the six gripping portions 111 are formed in the same direction as the forward direction in which the optical branching cables 1 are arranged side by side.

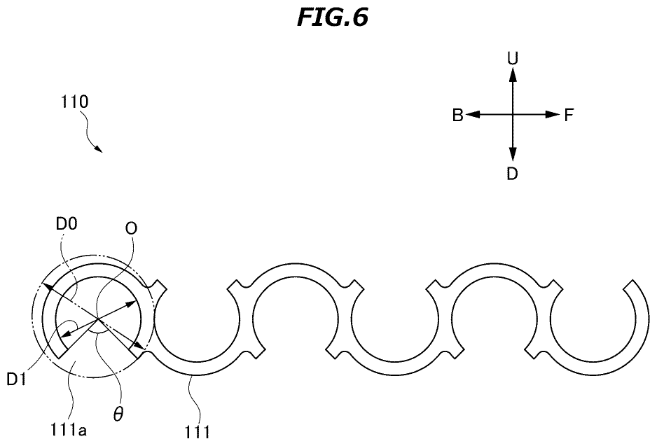

FIG. 6 is a cross-sectional view on arrow taken along a line VI-VI in FIG. 5. Note that in FIG. 6, the optical branching cable 1 is not shown. FIG. 6 shows a cross section of the gripping portion 111 taken along a plane perpendicular to the rightward direction, which is the first direction. In this cross section, an inner circumference of the gripping portion 111 is an arc with an opening 111a in a part of a circle. In this cross section, a central angle θ of the opening 111a with respect to an inner circumferential center O of one gripping portion 111 may be in a range of 50° to 90°. In the present embodiment, the central angle θ is 70°.

As shown in FIG. 6, in two adjacent gripping portions 111, the directions of the openings 111a of the two gripping portions 111 are different from each other with respect to the inner circumferential center of the gripping portions 111. In the present embodiment, the gripping portions 111 whose openings 111a are in the upward direction and the gripping portions 111 whose openings 111a are in the downward direction are alternately arranged side by side in the forward direction.

In FIG. 6, an outer circumference of the main cable 10 having an outer diameter DO when not gripped by the gripping portion 111 is indicated by a two-dot chain line. The inner circumference of the gripping portion 111 may be an arc having a diameter D1 in a range of 70% to 90% of the outer diameter of the main cable 10 of the optical branching cable 1 in the cross section. When the main cable 10 is gripped, the outer circumference of the main cable 10 is contracted to the diameter D1 of the gripping portion 111.

FIG. 7 illustrates the first holding jig 110 as viewed in a direction indicated by an arrow VII in FIG. 5. Note that in FIG. 7, the optical branching cable 1 is not shown. As shown in FIG. 7, the gripping portion 111 includes a central portion 1111 having a constant outer diameter, and a tapered portion 1112 including either the first end portion 111A or the second end portion 111B, and having an outer diameter that decreases toward the first end portion 111A or the second end portion 111B. In the present embodiment, the gripping portion 111 is formed with a first tapered portion 1112A and a second tapered portion 1112B of the tapered portion 1112 including the first end portion 111A.

When the central portion 1111 is in contact with a flat surface, an angle φ between the first tapered portion 1112A and the flat surface may be in a range of 5° to 15°. When the central portion 1111 is in contact with a flat surface, an angle φ between the second tapered portion 1112B and the flat surface may be in a range of 4° to 10°. In this case, the first end portion 111A and the second end portion 111B are separated from each other above the flat surface.

As shown in FIG. 4, in the present embodiment, among the twelve optical branching cables 1, the main cables 10 of the six optical branching cables 1 on the back side are gripped by the first holding jig 110, and the main cables 10 of the six optical branching cables 1 on the front side are gripped by the second holding jig 120. The six optical branching cables 1 gripped by the first holding jig 110 are referred to as a first optical cable group 1A. The six optical branching cables 1 gripped by the second holding jig 120 are referred to as a second optical cable group 1B. The second optical cable group 1B is disposed in front of the first optical cable group 1A side by side.

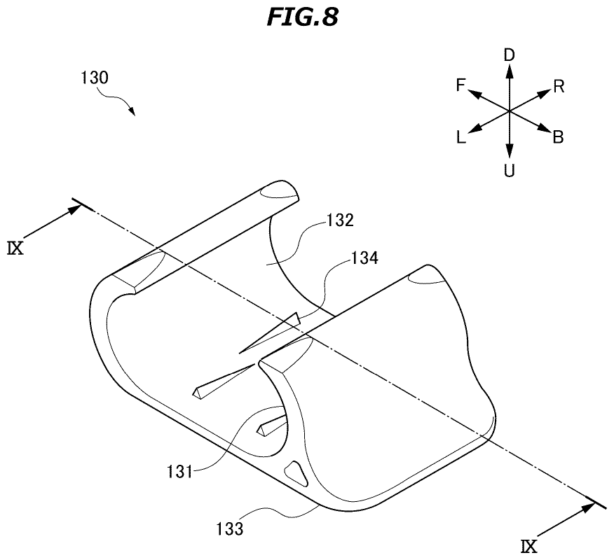

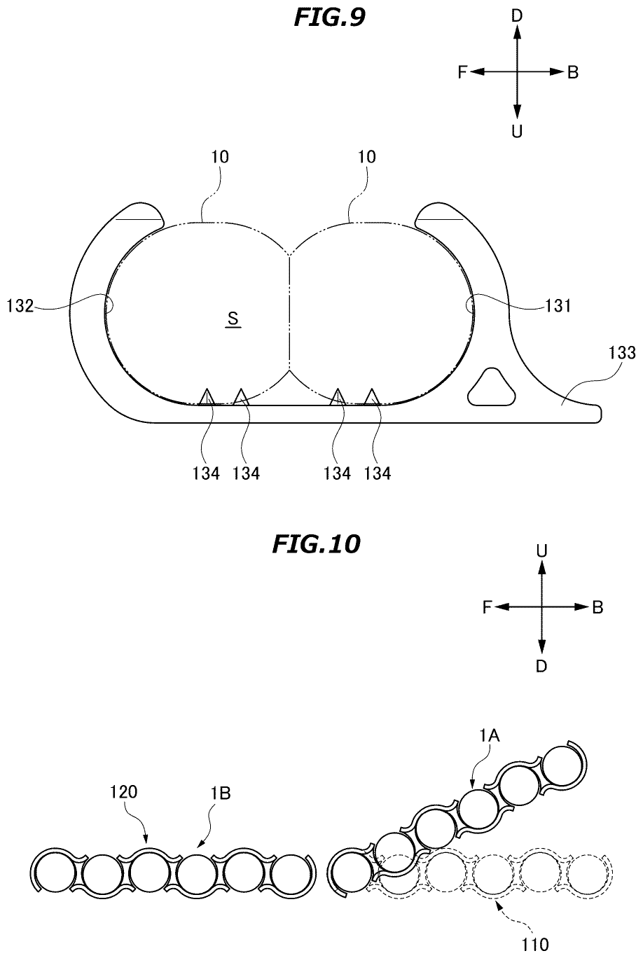

FIG. 8 is a perspective view of the third holding jig 130. FIG. 9 is a cross-sectional view on arrow taken along a line IX-IX in FIG. 8. Note that to facilitate the description, the third holding jig 130 shown in FIGS. 8 and 9 is upside down as compared with the third holding jig 130 shown in FIG. 4. As shown in FIGS. 8 and 9, the third holding jig 130 includes two gripping portions, that is, a first gripping portion 131 and a second gripping portion 132. In the third holding jig 130, a continuous accommodation space S is formed by the first gripping portion 131 and the second gripping portion 132.

The accommodation space S is capable of accommodating two main cables 10. In FIG. 9, the outer circumference of the main cable 10 accommodated in the accommodation space S is indicated by a two-dot chain line. One main cable 10 is in contact with the first gripping portion 131, and the other main cable 10 is in contact with the second gripping portion 132.

An extension portion 133 is formed on an outer surface of the third holding jig 130. The extension portion 133 extends in a direction from the first gripping portion 131 toward the second gripping portion 132. With the extension portion 133, even when the third holding jig 130 is attached to two optical branching cables 1 arranged side by side, the third holding jig 130 can be easily grasped by a hand of an operator.

Two or more protrusions 134 are formed at different positions on an inner surface of each of the first gripping portion 131 and the second gripping portion 132. In the present embodiment, two protrusions 134 are formed on the inner surface of each gripping portion. Accordingly, four protrusions 134 are formed in the accommodation space S. The protrusions 134 formed on the inner surfaces of the first gripping portion 131 and the second gripping portion 132 are formed to extend in the leftward direction or the rightward direction. Each inner surface includes a protrusion that decreases in height as protruding to the leftward direction and a protrusion that decreases in height as protruding to the rightward direction. A cross-sectional shape of each protrusion 134 may be triangular.

Return to FIG. 4. The first gripping portion 131 and the second gripping portion 132 of the third holding jig 130 hold the optical branching cable 1 disposed in the first optical cable group 1A adjacent to the optical branching cable 1 of the second optical cable group 1B, and the optical branching cable 1 disposed in the second optical cable group 1B adjacent to the optical branching cable 1 of the first optical cable group 1A. In other words, the third holding jig 130 is capable of holding the first optical cable group 1A and the second optical cable group 1B together.

FIG. 10 is a cross-sectional view taken along a plane perpendicular to the axis of the main cable 10 of the optical cable holding system 100. Note that in FIG. 10, the first optical cable group 1A in a state in which the first optical cable group 1A and the second optical cable group 1B are held by the third holding jig 130 is shown by a dashed line. The first optical cable group 1A in a state where the first optical cable group 1A and the second optical cable group 1B are not held together by the third holding jig 130 is shown by a solid line.

The optical branching cables 1 of the first optical cable group 1A are held side by side by the first holding jig 110. The optical branching cables 1 of the second optical cable group 1B are held side by side by the second holding jig 120. In a state in which the optical branching cables 1 are held by the first holding jig 110 and the second holding jig 120, the optical cable holding system 100 is drawn along the cable installation tray T, which is a drawing path. In this way, the first optical cable group 1A and the second optical cable group 1B can be maintained in an aligned state even when the optical cable holding system 100 is being drawn.

The cable installation tray T may be linear or curved. When the optical cable holding system 100 is drawn along the linear cable installation tray T, the main cable 10 of the optical branching cable 1 is drawn while being gripped by the first holding jig 110, the second holding jig 120, and the third holding jig 130. Therefore, the first optical cable group 1A and the second optical cable group 1B are arranged side by side in one direction.

When the optical cable holding system 100 is drawn along the curved cable installation tray T, the main cable 10 of the optical branching cable 1 is not gripped by the third holding jig 130. Therefore, the first optical cable group 1A can be separated from and rotate relative to the second optical cable group 1B. In this way, the optical cable holding system 100 can deform according to the curved cable installation tray T, and can be drawn smoothly along the curved cable installation tray T.

According to the first holding jig 110, the second holding jig 120, and the third holding jig 130 of the present embodiment, the plurality of gripping portions 111, the first gripping portion 131, and the second gripping portion 132 are coupled side by side so as to grip the plurality of optical branching cables 1 arranged in parallel. Therefore, when the main cables 10 of the plurality of optical branching cables 1 are gripped by the plurality of gripping portions 111, the first gripping portion 131, and the second gripping portion 132, the optical branching cables 1 can be easily maintained in a parallel state. For this reason, when the optical branching cables 1 attached with the first holding jig 110, the second holding jig 120, and the third holding jig 130 are drawn, the plurality of optical branching cables 1 can easily remain parallel to each other during and after the drawing operation, which is more efficient than drawing the optical branching cables 1 one by one and can reduce the work of aligning the optical branching cables 1 after drawing. In this way, workability of installation of the optical branching cables 1 is improved.

When the directions of the openings 111a in the plurality of gripping portions 111 are aligned with respect to the inner circumferential center O of the gripping portions 111, a reaction force when gripping the optical branching cables 1 may cause the first holding jig 110 and the second holding jig 120 to bend convexly in the direction in which the gripping portions 111 are open. According to the first holding jig 110 and the second holding jig 120 of the present embodiment, when attached to the optical branching cables 1, in adjacent gripping portions 111, the directions of the openings of the gripping portions 111 are different, making it difficult for the first holding jig 110 and the second holding jig 120 to bend in one direction.

According to the first holding jig 110 and the second holding jig 120 of the present embodiment, the inner circumference of each of the plurality of gripping portions 111 has a diameter D1 in the cross section in a range of 70% to 90% of the outer diameter DO of the main cable 10, so that the optical branching cable 1 is less likely to fall off from the plurality of gripping portions 111.

According to the third holding jig 130 of the present embodiment, two or more protrusions 134 are formed at different positions on the inner surfaces of the first gripping portion 131 and the second gripping portion 132. The protrusions 134 make it difficult for the optical branching cable 1 to be displaced or rotated inside the first gripping portion 131 and the second gripping portion 132 when the main cable 10 of the optical branching cable 1 is gripped by the first gripping portion 131 and the second gripping portion 132. In this way, it becomes difficult for the optical branching cable 1 to fall off from the first gripping portion 131 and the second gripping portion 132 or for the optical branching cable 1 to be twisted.

According to the first holding jig 110 and the second holding jig 120 of the present embodiment, the central portion 1111 having a constant outer diameter, the first tapered portion 1112A whose outer diameter decreases toward the first end portion 111A, and the second tapered portion 1112B whose outer diameter decreases toward the second end portion 111B are provided. When the cable installation tray T, which is the drawing path, is flat, the first holding jig 110 and the second holding jig 120 are drawn with the central portion 1111 having a constant outer diameter in contact with the traveling surface, so that the postures of the first holding jig 110 and the second holding jig 120 during drawing are stable. On the other hand, when a protrusion is formed on the cable installation tray T, the first tapered portion 1112A and the second tapered portion 1112B will come into contact with the protrusion, making it easier for the first holding jig 110 and the second holding jig 120 to climb over the protrusion. In this way, workability of installation of the optical branching cables 1 is improved.

According to the third holding jig 130 of the present embodiment, the continuous accommodation space S is formed by the first gripping portion 131 and the second gripping portion 132, and two optical branching cables 1 can be accommodated in the accommodation space S. Since two optical branching cables 1 can be held in one accommodation space S, the shape of the first gripping portion 131 and the second gripping portion 132 are simple. Since the extension portion 133 is formed on the third holding jig 130, the optical branching cable 1 can be easily taken out from the accommodation space S by holding the extension portion 133.

According to the drawing method for the optical cable holding system 100 and the optical branching cables 1 of the present embodiment, the first holding jig 110, the second holding jig 120, and the third holding jig 130 are attached to the optical branching cable 1, making it easier to maintain the plurality of optical branching cables 1 in a parallel state even during the installation work. When the optical branching cables 1 in which the main cables 10 are gripped by the first holding jig 110, the second holding jig 120, and the third holding jig 130 are drawn, the plurality of optical branching cables 1 can easily remain parallel to each other even after the drawing operation, which is more efficient than drawing the optical cables one by one and can reduce the work of aligning the optical branching cables 1 after drawing. In this way, workability of installation of the optical branching cables 1 is improved.

According to the drawing method for the optical cable holding system 100 and the optical branching cables 1 of the present embodiment, the first optical cable group 1A and the second optical cable group 1B are held by the third holding jig 130. When the optical cable holding system 100 is drawn along a linear cable installation tray T, the optical cable holding system 100 is drawn in a state in which the first optical cable group 1A and the second optical cable group 1B are held by the third holding jig 130, so that the first optical cable group 1A and the second optical cable group 1B are drawn in a parallel state. When the optical cable holding system 100 is drawn along a curved cable installation tray T, the optical cable holding system 100 is drawn in a state in which the holding of the first optical cable group 1A and the second optical cable group 1B by the third holding jig 130 is released, so that the first optical cable group 1A can adopt a free position relative to the second optical cable group 1B. The optical cable holding system 100 is drawn while being deformed along the curved cable installation tray T, and thus can travel smoothly along the curved cable installation tray T. In this way, workability of installation of the optical branching cables 1 is improved.

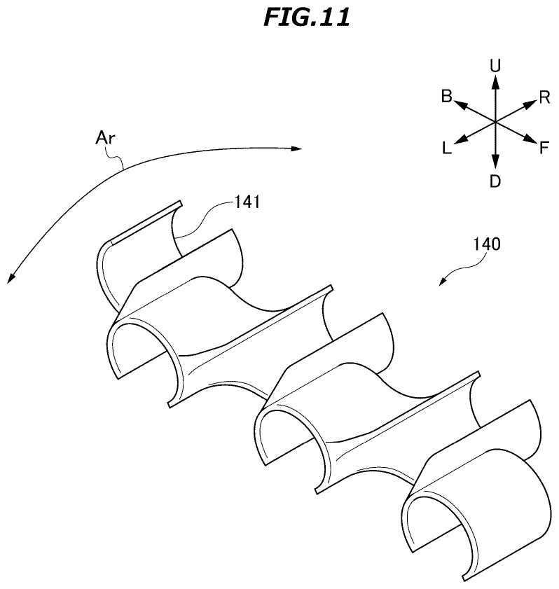

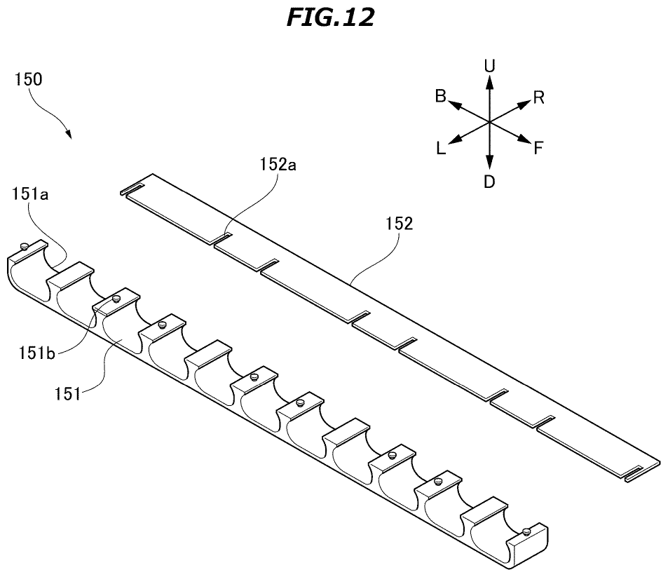

Next, a holding jig according to a modification will be described. FIG. 11 shows a holding jig 140 according to a first modification. As shown in FIG. 11, in the holding jig 140 according to the first modification, adjacent gripping portions 141 are formed at different positions in the rightward direction, which is the first direction. Adjacent gripping portions 141 being formed at different positions in the rightward direction means in adjacent gripping portions 141, the positions of either the end portions in the rightward direction or the end portions in the leftward direction of the gripping portions 141 are not aligned. In the first modification, the gripping portions 141 leaning to the leftward direction and the gripping portions 141 leaning to the rightward direction are alternately arranged side by side in the forward direction.

In the holding jig 140 according to the first modification, the adjacent gripping portions 141 are formed at different positions in the rightward direction. Therefore, the holding jig 140 has flexibility to deform so that the gripping portion 141 rotates in the direction of an arrow Ar in FIG. 11 relative to the adjacent gripping portion 141. As a result, even when the cable installation tray T is not flat or is curved, the holding jig 140 is deformed while the optical branching cables 1 are being drawn, so that the optical branching cables 1 can be easily maintained in a parallel state.

FIG. 12 shows a holding jig 150 according to a second modification. As shown in FIG. 12, the holding jig 150 includes gripping portions 151 and a lid 152. In a cross section of the gripping portions 151 taken along a plane perpendicular to the rightward direction, which is the first direction, an inner circumference of each of the gripping portions 151 is an arc having an opening in a part of a circle.

In the holding jig 150 according to the second modification, in two adjacent gripping portions 151, the directions of the openings 151a of the two gripping portions 151 are the same with respect to an inner circumferential center of the gripping portions 151. The gripping portions 151 of the holding jig 150 according to the second modification are all open in the upward direction.

The lid 152 is formed so as to be able to cover the openings of the gripping portions 151. The lid 152 is formed with a plurality of notches 152a. The notches 152a of the lid 152 is formed so as to be able to engage with engagement portions 151b formed to protrude upward from the gripping portions 151. By engaging the notches 152a with the engagement portions 151b, the lid 152 can be attached to the gripping portions 151 so as to close the openings 151a of the gripping portions 151 while the optical branching cables 1 are gripped by the gripping portions 151.

According to the holding jig 150 of the second modification, the lid 152 closes the openings of the gripping portions 151, so that the optical branching cables 1 are less likely to fall off from the gripping portions 151. When the plurality of gripping portions 151 are open in, for example, only one direction, a reaction force when gripping the optical branching cables 1 tends to cause the holding jig 150 to bend convexly in the direction in which the gripping portions 151 are open. By closing the openings of the gripping portions 151 with the lid 152, the holding jig 150 is less likely to bend in one direction.

Although the present disclosure has been described in detail with reference to the specific embodiment, it is apparent to those skilled in the art that various changes and modifications can be made without departing from the spirit and scope of the present disclosure. In addition, the number, positions, shapes, and the like of the constituent members described above are not limited to those in the above embodiments, and can be changed to the numbers, positions, shapes, and the like suitable for carrying out the present disclosure.

In the present embodiment, the optical branching cable 1 has been described as an example of the optical cable. However, even in the case of an optical cable that does not include the branching cord portion 20, the use of the holding jig of the present disclosure can improve the workability of installation of the optical cable.

In the present embodiment, the six gripping portions 111 are formed as a one-piece monolithic component, but separate gripping portions may be directly coupled to each other or may be coupled via coupling components.

In the present embodiment, the protrusion 134 is formed so as to extend in the rightward direction, but the shape of the protrusion 134 is not limited to the example shown in the present embodiment. For example, the protrusion 134 may be a point-like protrusion in a plan view. The protrusion 134 may be formed on the gripping portion 111 of the first holding jig 110 and the second holding jig.

What is claimed is:

1. A holding jig attachable to a plurality of optical cables to hold the plurality of optical cables in parallel to each other, the holding jig comprising:
a plurality of gripping portions, each of the plurality of gripping portions being configured to grip a sheath of an optical cable,
wherein each of the plurality of gripping portions comprises a first end portion and a second end portion and extends in a first direction, the first direction being, in a state in which the sheath of the optical cable is gripped, a direction from the first end portion toward the second end portion which is along an axis of the optical cable and also a direction parallel to the axis of the optical cable, and
wherein the plurality of gripping portions are coupled side by side so as to grip the plurality of optical cables arranged in parallel.

2. The holding jig according to claim 1,
wherein in a cross section of each of the plurality of gripping portions taken along a plane perpendicular to the first direction, an inner circumference of each of the plurality of gripping portions defines an arc with an opening in a part of a circle, and wherein in two adjacent gripping portions of the plurality of gripping portions, directions in which openings of the two adjacent gripping portions are positioned with respect to respective inner circumferential centers of the two adjacent gripping portions are different from each other.

3. The holding jig according to claim 2,
wherein the arc defined by the inner circumference of each of the plurality of gripping portions has a diameter in a range of 70% to 90% of an outer diameter of the optical cable.

4. The holding jig according to claim 1,
wherein two or more protrusions are formed at different positions on an inner surface of each of the plurality of gripping portions.

5. The holding jig according to claim 1,
wherein each of the plurality of gripping portions comprises:
a central portion having a constant outer diameter; and
a tapered portion comprising an end portion which is one of the first end portion and the second end portion, the tapered portion having an outer diameter that decreases toward the end portion.

6. The holding jig according to claim 1,
wherein adjacent ones of the plurality of gripping portions are formed at different positions in the first direction.

7. The holding jig according to claim 1,
wherein in a cross section of each of the plurality of gripping portions taken along a plane perpendicular to the first direction, an inner circumference of each of the plurality of gripping portions defines an arc with an opening in a part of a circle,
wherein in two adjacent gripping portions of the plurality of gripping portions, directions in which openings of the two adjacent gripping portions are positioned with respect to respective inner circumferential centers of the two adjacent gripping portions are a same direction,
wherein the holding jig further comprises a lid configured to close openings of the plurality of gripping portions, and
wherein the lid is attachable to the plurality of gripping portions so as to close the openings of the plurality of gripping portions in a state in which the plurality of optical cables are gripped by the plurality of gripping portions.

8. The holding jig according to claim 1,
wherein the plurality of gripping portions comprise a first gripping portion and a second gripping portion,
wherein the first gripping portion and the second gripping portion define a continuous accommodation space configured to accommodate two of the plurality of optical cables, and
an extension portion is formed on an outer surface of the holding jig, the extension portion extending in a direction from the first gripping portion toward the second gripping portion.

9. An optical cable holding system comprising:
the holding jig according to claim 1; and
two or more optical cables, a number of the two or more optical cables being equal to or less than a total number of optical cables that are permitted to be gripped by the plurality of gripping portions,
wherein the two or more optical cables are gripped by respective two or more gripping portions of the plurality of gripping portions such that the two or more optical cables are arranged in parallel.

10. An optical cable holding system comprising:
a plurality of optical cables;
a first holding jig attachable to a first optical cable group including at least two optical cables of the plurality of optical cables to hold the at least two optical cables in parallel to each other, the first holding jig comprising a plurality of first gripping portions, each of the plurality of first gripping portions being configured to grip a sheath of an optical cable;
a second holding jig attachable to a second optical cable group including at least two other optical cables of the plurality of optical cables to hold the at least two other optical cables in parallel to each other, the second holding jig comprising a plurality of second gripping portions, each of the plurality of second gripping portions being configured to grip a sheath of an optical cable; and
a third holding jig comprising two third gripping portions, each of the two third gripping portions being configured to grip a sheath of an optical cable,
wherein each gripping portion among each of the plurality of first gripping portions, each of the plurality of second gripping portions, and each of the two third gripping portions comprises a first end portion and a second end portion and extends in a first direction, the first direction being, in a state in which the sheath of the optical cable is gripped, a direction from the first end portion toward the second end portion which is along an axis of the optical cable and also a direction parallel to the axis of the optical cable,
wherein the plurality of first gripping portions are coupled side by side so as to grip the at least two optical cables included in the first optical cable group,
wherein the plurality of second gripping portions are coupled side by side so as to grip the at least two other optical cables included in the second optical cable group,
wherein the two third gripping portions define a continuous accommodation space configured to accommodate two of the plurality of optical cables,
wherein a number of the plurality of optical cables is two or more and equal to or less than a total number of optical cables that are permitted to be gripped by the plurality of first gripping portions and the plurality of second gripping portions,
wherein the first optical cable group and the second optical cable group are arranged side by side such that a first optical cable contained in the first optical cable group and a second optical cable contained in the second optical cable group are positioned adjacent to each other, and
wherein the third holding jig is configured to hold the first optical cable and the second optical cable in a state in which the first optical cable and the second optical cable are accommodated in the continuous accommodation space.

11. An optical cable drawing method for drawing the two or more optical cables in the optical cable holding system according to claim 9, the optical cable drawing method comprising:
drawing the optical cable holding system along a drawing path in a state in which the two or more optical cables are held by the holding jig.

12. An optical cable drawing method for drawing the plurality of optical cables in the optical cable holding system according to claim 10, the optical cable drawing method comprising:
drawing the optical cable holding system along a drawing path,
wherein in a case in which the drawing path is a linear drawing path, the optical cable holding system is drawn in a state in which the plurality of optical cables are gripped by the first holding jig, the second holding jig, and the third holding jig, and
wherein in a case in which the drawing path is a curved drawing path, the optical cable holding system is drawn in a state in which the plurality of optical cables are gripped by the first holding jig and the second holding jig but not gripped by the third holding jig.
